(19) United States
(12) Patent Application Publication
(10) Pub. No.: US 2026/0234975 A1
(43) Pub. Date: Aug. 13, 2026

(54) CARRIER PLATE AND WINDOW REGULATOR

(71) Applicant: HI-LEX Corporation, Hyogo (JP)

(72) Inventor: Shingo KAWAI, Hyogo (JP)

(73) Assignee: HI-LEX Corporation, Hyogo (JP)

(21) Appl. No.: 19/160,048

(22) PCT Filed: Feb. 28, 2024
(86) PCT No.: PCT/JP2024/007217

§ 371 Date: Aug. 27, 2025

(30) Foreign Application Priority Data
Feb. 28, 2023 (JP) 2023-029580

(51) Int. Cl. E05D 15/16; E05F 15/689

(52) U.S. Cl. CPC E05D 15/165; E05F 15/6909; E05Y 2600/50; E05Y 2900/55

(57) ABSTRACT

A carrier plate is a carrier plate that is pulled by a cable to slide on a guide rail to raise and lower a window glass, including: a cable end accommodation section that accommodates an end of the cable, and an accommodation groove that accommodates the cable extending from the cable end accommodation section to an outside of the carrier plate, in which a protrusion that contacts the cable is formed only on one sidewall of two opposing sidewalls of the accommodation groove. Such a structure can provide a carrier plate and window regulator achieving a balanced realization of cable vibration suppression and ease of cable sliding.

### TECHNICAL FIELD

The present invention relates to a carrier plate and a window regulator.

### BACKGROUND ART

Conventionally, window regulators that raise and lower window glass by pulling a carrier plate holding the window glass with a cable and sliding it on a guide rail are widely used. Window regulators are provided in places such as car doors.

For example, Patent Literature (hereinafter referred to as “PTL”) 1 discloses a window regulator in which an S-shaped curved groove is formed in a carrier plate, a cable is fit into the groove to hold it, thereby suppressing cable vibration and reducing noise caused by cable vibration.

### CITATION LIST

### Patent Literature

PTL 1
Japanese Patent Application Laid-Open No. 2018-66192

### SUMMARY OF INVENTION

### Technical Problem

In the window regulator of PTL 1 mentioned above, a spring is provided in a housing section that houses the cable end, and the cable is pulled by a spring force to prevent slack. However, in such a configuration, the cable is strongly pressed from both sides by the S-shaped groove, making it difficult for the cable to slide within the groove, and preventing cable slack becomes challenging.

The present invention has been made in view of such problems, and aims to provide a carrier plate and window regulator that achieve a balanced suppression of cable vibration and ease of cable sliding.

### Solution to Problem

To achieve the above objectives, the carrier plate in the present invention is a carrier plate that is pulled by a cable to slide on a guide rail to raise and lower a window glass, and includes: a cable end accommodation section that accommodates an end of the cable; and an accommodation groove that accommodates the cable extending from the cable end accommodation section to an outside of the carrier plate, in which a protrusion that contacts the cable is formed only on one sidewall of two opposing sidewalls of the accommodation groove.

The window regulator in the present invention includes the above carrier plate.

### Advantageous Effects of Invention

The carrier plate and window regulator according to the present invention can achieve a balanced suppression of cable vibration and ease of cable sliding.

### BRIEF DESCRIPTION OF DRAWINGS

FIG. 1 is a front view of a window regulator according to an embodiment of the present invention;

FIG. 2 is a side view of the window regulator;

FIG. 3 is a front view of a carrier plate assembled to a guide rail;

FIG. 4 is a rear view of the carrier plate assembled to the guide rail;

FIG. 5 is a perspective view of the carrier plate showing a protrusion formed on a sidewall of a lowering-side cable accommodation groove that accommodates a lowering-side cable; and

FIG. 6 is a rear view of the carrier plate showing the protrusion formed on the sidewall of the lowering-side cable accommodation groove that accommodates the lowering-side cable.

### DESCRIPTION OF EMBODIMENTS

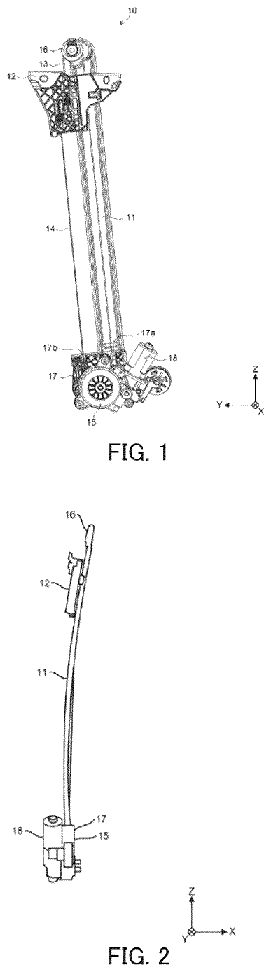

Window regulator 10 according to an embodiment of the present invention will be described with reference to FIGS. 1 and 2. FIG. 1 is a front view of window regulator 10 according to an embodiment of the present invention. FIG. 2 is a side view of window regulator 10.

In the figures shown in the present embodiment, the X-axis, Y-axis, and Z-axis are indicated. The X-axis indicates the thickness direction of carrier plate 12 described below, the Y-axis indicates the width direction of carrier plate 12, and the Z-axis indicates the raising and lowering direction of carrier plate 12.

Window regulator 10 is supported by a vehicle door panel (not shown). Window regulator 10 is a mechanism for raising and lowering a window glass (not shown), which is an object to be moved.

As shown in FIGS. 1 and 2, window regulator 10 mainly includes guide rail 11, carrier plate 12, raising-side cable 13, lowering-side cable 14, and drive unit 15.

Guide rail 11 is provided along the raising and lowering direction of the window glass and is a member that guides carrier plate 12 in the raising and lowering direction of the window glass. Guide rail 11 extends generally in the vehicle vertical direction (Z direction) and is provided to be slightly inclined with respect to the window glass (not shown) to be attached.

Also, as shown in FIG. 2, guide rail 11 is gently curved to match the curvature of the car window glass. Guide rail 11 is made of, for example, stainless steel, aluminum alloy, or other hard materials.

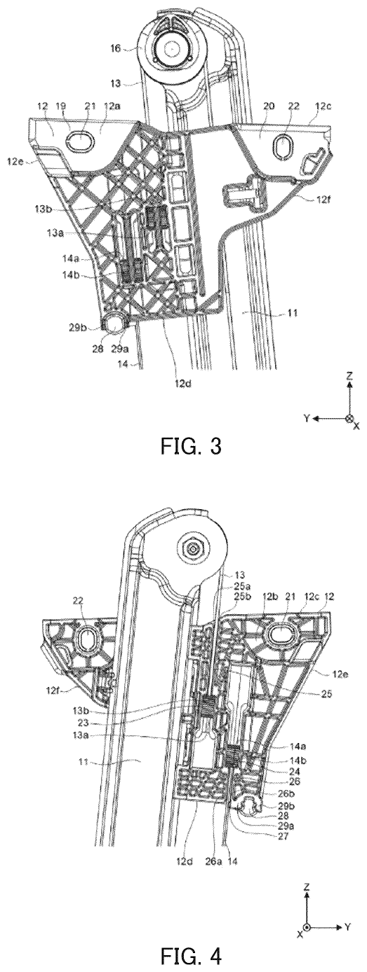

FIG. 3 is a front view of carrier plate 12 assembled to guide rail 11 as seen from the front side. Carrier plate 12 is a member that holds the lower end portion of the window glass and is pulled by raising-side cable 13 or lowering-side cable 14 to slide on guide rail 11, thereby raising and lowering the window glass. The structure of carrier plate 12 will be described in detail later.

As shown in FIG. 1, pulley 16 is provided at the upper end of guide rail 11 as a direction changing member for changing the movement direction of raising-side cable 13.

At the lower end of guide rail 11, drive unit 15 is provided for winding and unwinding raising-side cable 13 and lowering-side cable 14. Drive unit 15 includes drum housing 17, a drum (not shown), and drive motor 18.

Drum housing 17 has a fitting part that fits to guide rail 11 and a cylindrical drum housing part. A cylindrical recess for accommodating the drum is formed in the drum housing part. Furthermore, drum housing 17 has raising-side cable lead-out groove 17a and lowering-side cable lead-out groove 17b for leading out raising-side cable 13 and lowering-side cable 14 from the recess.

Drum housing 17 rotatably supports the drum. Drive motor 18 is integrally attached to drum housing 17 and rotationally drives the drum in both forward and reverse directions. Also, drum housing 17 is attached to the lower end portion of guide rail 11 and fixes guide rail 11 to the vehicle door panel (not shown).

Raising-side cable 13 and lowering-side cable 14 pull carrier plate 12 in the vertical direction (Z direction). Known cables composed of multiple metal wires or resin fiber wires can be used for raising-side cable 13 and lowering-side cable 14.

Raising-side cable 13 has one end connected to carrier plate 12, is looped around pulley 16, and the other end is connected to the drum. Lowering-side cable 14 includes one end connected to carrier plate 12, and the other end connected to the drum.

By rotating the drum with drive motor 18, raising-side cable 13 and lowering-side cable 14 are wound and unwound.

FIG. 4 is a rear view of carrier plate 12 assembled to guide rail 11 as seen from the back side. At one ends of raising-side cable 13 and lowering-side cable 14, raising-side cable end 13a and lowering-side cable end 14a are provided, respectively.

Raising-side cable end 13a and lowering-side cable end 14a are formed, for example, by die-casting a metal material, and respectively include base ends to which one ends of raising-side cable 13 and lowering-side cable 14 are attached, and flange portions with a larger outer diameter than the base ends.

Each of the base ends is formed in a cylindrical or truncated cone shape and is fixed to one end of raising-side cable 13 or lowering-side cable 14 by casting, caulking, bonding, welding, bolting, or other methods.

Coil springs 13b and 14b are mounted on raising-side cable end 13a and lowering-side cable end 14a, respectively. Coil springs 13b and 14b are biasing members that bias raising-side cable end 13a and lowering-side cable end 14a in the direction of taking up slack in raising-side cable 13 and lowering-side cable 14, respectively.

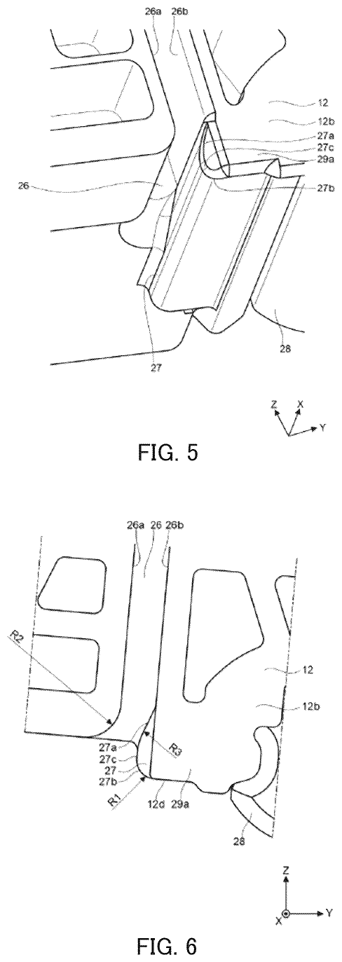

Next, the structure of carrier plate 12 in the present embodiment will be described using FIGS. 3 and 4, as well as FIGS. 5 and 6.

FIG. 5 is a perspective view of carrier plate 12 showing protrusion 27 formed on sidewall 26b of lowering-side cable accommodation groove 26 that accommodates lowering-side cable 14. FIG. 6 is a rear view of carrier plate 12 showing protrusion 27 formed on sidewall 26b of lowering-side cable accommodation groove 26 that accommodates lowering-side cable 14.

As shown in FIGS. 3 and 4, carrier plate 12 has front surface 12a, rear surface 12b, upper edge portion 12c, lower edge portion 12d, left edge portion 12e, and right edge portion 12f.

Front surface 12a is on the negative side of the X-axis, and rear surface 12b is on the positive side of the X-axis. Upper edge portion 12c is an outer peripheral edge of carrier plate 12, located on the positive side of the Z-axis, extending from an end on the negative side of the Y-axis to an end on the positive side of the Y-axis. Lower edge portion 12d is an outer peripheral edge of carrier plate 12, located on the negative side of the Z-axis, extending from the end on the negative side of the Y-axis to the end on the positive side of the Y-axis.

Left edge portion 12e is an outer peripheral edge of carrier plate 12, located on the positive side of the Y-axis, extending diagonally from an end on the negative side of the Z-axis to an end on the positive side of the Z-axis. Right edge portion 12f is an outer peripheral edge of carrier plate 12, located on the negative side of the Y-axis, extending diagonally from the end on the negative side of the Z-axis to the end on the positive side of the Z-axis.

Mounting parts 19 and 20 are provided on front surface 12a. Holes 21 and 22 through which bolts pass are formed in mounting parts 19 and 20, and holders (not shown) for holding the window glass (not shown) are fastened to mounting parts 19 and 20 with bolts.

On rear surface 12b, there are provided raising-side cable end accommodation section 23, lowering-side cable end accommodation section 24, raising-side cable accommodation groove 25, and lowering-side cable accommodation groove 26.

Raising-side cable end accommodation section 23 accommodates the end of raising-side cable 13. Specifically, raising-side cable end accommodation section 23 accommodates raising-side cable end 13a connected to one end of raising-side cable 13, and coil spring 13b attached to raising-side cable end 13a.

Lowering-side cable end accommodation section 24 accommodates the end of lowering-side cable 14. Specifically, lowering-side cable end accommodation section 24 accommodates lowering-side cable end 14a connected to one end of lowering-side cable 14, and coil spring 14b attached to lowering-side cable end 14a.

Raising-side cable accommodation groove 25 accommodates raising-side cable 13 extending from raising-side cable end accommodation section 23 to the outside of carrier plate 12. Raising-side cable accommodation groove 25 has two opposing sidewalls 25a and 25b.

Sidewall 25a is the sidewall located on the side where guide rail 11 is provided, and sidewall 25b is the sidewall located on the side opposite to the side where guide rail 11 is provided. Sidewall 25b protrudes more towards the outside of carrier plate 12 than sidewall 25a in the longitudinal direction.

Lowering-side cable accommodation groove 26 accommodates lowering-side cable 14 extending from lowering-side cable end accommodation section 24 to the outside of carrier plate 12. Lowering-side cable accommodation groove 26 has two opposing sidewalls 26a and 26b.

Sidewall 26a is the sidewall located on the side where guide rail 11 is provided, and sidewall 26b is the sidewall located on the side opposite to the side where guide rail 11 is provided. Sidewall 26b protrudes more towards the outside of carrier plate 12 than sidewall 26a in the longitudinal direction.

In the present embodiment, protrusion 27 that contacts lowering-side cable 14 when lowering-side cable 14 is accommodated in lowering-side cable accommodation groove 26 is formed only on sidewall 26b among sidewalls 26a and 26b.

By protrusion 27 contacting lowering-side cable 14, it is possible to suppress vibration of lowering-side cable 14 and reduce abnormal noise when the car door is closed, for example.

Furthermore, by providing protrusion 27 only on sidewall 26b among sidewalls 26a and 26b, it is possible to achieve a good balance between suppressing vibration of lowering-side cable 14 and facilitating the sliding of lowering-side cable 14 compared to providing protrusions on both sidewalls 26a and 26b.

Furthermore, window regulator 10 shown in FIG. 1 pulls raising-side cable 13 to raise carrier plate 12 on guide rail 11. When the upper end of carrier plate 12 is constrained at the upper end position, a portion of carrier plate 12 on the positive side of the Y-axis relative to guide rail 11 is pulled to the positive side of the Z-axis by raising-side cable 13, causing carrier plate 12 to slightly rotate clockwise when viewed from the negative side of the X-axis.

In this case, lowering-side cable 14 moves towards sidewall 26a on the side where guide rail 11 is provided.

Therefore, if protrusion 27 is provided on sidewall 26b opposite to the side where guide rail 11 is provided, even if lowering-side cable 14 moves towards sidewall 26a, lowering-side cable 14 will not be strongly pressed against protrusion 27. As a result, it is possible to prevent lowering-side cable 14 from being damaged due to bending fatigue.

Additionally, protrusion 27 is formed at an end among the two longitudinal ends of sidewall 26b which is opposite to the side of lowering-side cable end accommodation section 24. This allows lowering-side cable 14 to contact protrusion 27 at a point as far away as possible from lowering-side cable end accommodation section 24, thereby further suppressing the vibration of lowering-side cable 14 and increasing the effect of reducing abnormal noise.

Furthermore, elastic body 28 such as rubber is provided on lower edge portion 12d to cushion the impact when carrier plate 12 contacts drum housing 17. The portion of sidewall 26b where protrusion 27 is provided forms one holding section 29a of two holding sections 29a and 29b that hold elastic body 28 from both sides, holding section 29a being located on the side where guide rail 11 is provided.

By providing protrusion 27 on sidewall 26b, which functions as holding section 29a, there is no need to add a new component to carrier plate 12, thus simplifying the shape of carrier plate 12 and allowing it to be miniaturized.

Next, the shape of protrusion 27 will be described in more detail. FIGS. 5 and 6 show the configuration of carrier plate 12 near protrusion 27.

As shown in FIG. 6, the end of sidewall 26a located opposite lowering-side cable end accommodation section 24 is formed in an arc shape with radius of curvature R2.

This allows lowering-side cable 14 to be easily accommodated in lowering-side cable accommodation groove 26 even if protrusion 27 is provided on sidewall 26b.

Also, as previously mentioned, even if lowering-side cable 14 moves towards sidewall 26a as a result of pulling raising-side cable 13 to raise carrier plate 12 on guide rail 11, lowering-side cable 14 contacts the arc-shaped end of sidewall 26a, preventing it from being pressed against an angular part. Therefore, it is possible to prevent lowering-side cable 14 from being damaged due to bending fatigue.

Additionally, protrusion 27 provided at the end of sidewall 26b opposite to lowering-side cable end accommodation section 24 includes first portion 27a on the side of lowering-side cable end accommodation section 24, second portion 27b on the side opposite to the side of lowering-side cable end accommodation section 24, and third portion 27c connecting first portion 27a and second portion 27b between first portion 27a and second portion 27b.

When rear surface 12b of carrier plate 12 is viewed from a direction perpendicular to rear surface 12b, first portion 27a and second portion 27b are formed in an arc shape, and radius of curvature R3 of first portion 27a is larger than radius of curvature R1 of second portion 27b.

Third portion 27c is formed to have a linear portion parallel to the longitudinal direction of lowering-side cable accommodation groove 26 when rear surface 12b of carrier plate 12 is viewed from a direction perpendicular to rear surface 12b.

First portion 27a is a portion that guides lowering-side cable 14 accommodated in lowering-side cable accommodation groove 26 to third portion 27c. Second portion 27b is a portion that guides lowering-side cable 14 to the outside of carrier plate 12. Additionally, third portion 27c is a portion that guides lowering-side cable 14 in the longitudinal direction of lowering-side cable accommodation groove 26.

By making radius of curvature R3 of first portion 27a larger than radius of curvature R1 of second portion 27b, it is possible to prevent large bending stress from occurring on lowering-side cable 14 at first portion 27a, and also to prevent lowering-side cable 14 from contacting an angular portion at second portion 27b, thereby preventing deterioration of the strength of lowering-side cable 14.

In the above embodiment, the case where protrusion 27 is provided only on sidewall 26b opposite to the side where guide rail 11 is provided has been described, but it is also possible to provide the protrusion only on sidewall 26a on the side where guide rail 11 is provided, so that protrusion contacts lowering-side cable 14.

Additionally, while protrusion 27 is formed at the end among the two longitudinal ends of sidewall 26b which is opposite to the side of lowering-side cable end accommodation section 24, it is also possible for protrusion 27 to be provided closer to the side of lowering-side cable end accommodation section 24 than that end.

Even in these cases, it is possible to suppress the vibration of lowering-side cable 14 and reduce abnormal noise.

In the above embodiment, in the longitudinal direction, sidewall 26b protrudes more than sidewall 26a, and the protruding portion forms holding section 29a that holds elastic body 28 to cushion the impact when carrier plate 12 contacts drum housing 17, but if the protrusion is provided on the carrier plate without elastic body 28, sidewall 26b does not necessarily have to protrude more than sidewall 26a.

Furthermore, the shape of protrusion 27 is not limited to being formed by first portion 27a with radius of curvature R3, second portion 27b with radius of curvature R1, and third portion 27c connecting first portion 27a to second portion 27b, and may be any shape as long as the protrusion contacts lowering-side cable 14.

Furthermore, in the above embodiment, the protrusion is formed only on sidewall 26b among two opposing sidewalls 26a and 26b of lowering-side cable accommodation groove 26, but it is also possible for the protrusion to be formed only on one of sidewalls 25a or 25b of the two opposing sidewalls of raising-side cable accommodation groove 25.

In this case, it is possible to achieve a good balance between suppressing the vibration of raising-side cable 13 and facilitating the sliding of raising-side cable 13.

While a preferred embodiment of the present invention has been described above, the present invention is not limited to the embodiment described above, but various changes are possible without departing from the spirit of the present invention. In particular, a plurality of embodiments and variations described herein may be arbitrarily combined as needed.

### INDUSTRIAL APPLICABILITY

The present invention is applicable to a window regulator for driving a window glass of an automobile up and down.

### REFERENCE SIGNS LIST

10 Window regulator
11 Guide rail
12 Carrier plate
12a Front surface
12b Rear surface
12c Upper edge portion
12d Lower edge portion
12e Left edge portion
12f Right edge portion
13 Raising-side cable
13a Raising-side cable end
13b Coil spring
14 Lowering-side cable
14a Lowering-side cable end
14b Coil spring
15 Drive unit
16 Pulley
17 Drum housing
18 Drive motor
19, 20 Mounting part
21, 22 Hole
23 Raising-side cable end accommodation section
24 Lowering-side cable end accommodation section
25 Raising-side cable accommodation groove
25a, 25b Sidewall
26 Lowering-side cable accommodation groove
26a, 26b Sidewall
27 Protrusion
27a First portion of protrusion
27b Second portion of protrusion
27c Third portion of protrusion
28 Elastic body
29a, 29b Holding section

1. A carrier plate that is pulled by a cable to slide on a guide rail to raise and lower a window glass, the carrier plate comprising:
a cable end accommodation section that accommodates an end of the cable; and
an accommodation groove that accommodates the cable extending from the cable end accommodation section to an outside of the carrier plate, wherein
a protrusion that contacts the cable is formed only on one sidewall of two opposing sidewalls of the accommodation groove.

2. The carrier plate according to claim 1, wherein
the one sidewall is a sidewall located on a side opposite to a side on which the guide rail is provided.

3. The carrier plate according to claim 1, wherein
the protrusion is formed at an end portion of two end portions of the one sidewall in a longitudinal direction, the end portion being located on a side opposite to the cable end accommodation section side.

4. The carrier plate according to claim 3, wherein
the one sidewall protrudes more than another sidewall of the two opposing sidewalls in the longitudinal direction.

5. The carrier plate according to claim 4, wherein
a portion of the one sidewall that protrudes more than the other sidewall holds an elastic body to cushion an impact caused when the carrier plate contacts another member.

6. The carrier plate according to claim 3, wherein
when a surface of the carrier plate is viewed from a direction perpendicular to the surface, a radius of curvature of a first portion of the protrusion located on the cable end accommodation section side is larger than a radius of curvature of a second portion of the protrusion located on the side opposite to the cable end accommodation section side.

7. The carrier plate according to claim 6, wherein
when the surface of the carrier plate is viewed from the direction perpendicular to the surface, the protrusion includes a linear portion between the first portion and the second portion, the linear portion connecting the first portion and the second portion.

8. A window regulator, comprising:
the carrier plate according to claim 1.
